(19) United States
(12) Patent Application Publication
(10) Pub. No.: US 2005/0050793 A1
(43) Pub. Date: Mar. 10, 2005

(54) Weed barrier and artificial mulch with degradable portion and related method

(76) Inventors: Randy Johnson, Lula, GA (US); Tracey Johnston, Ringgold, GA (US); Randy Alan Bruinsma, Alpharetta, GA (US)

Correspondence Address: RENNER, KENNER, GREIVE, BOBAK, TAYLOR & WEBER, FIRST NATIONAL TOWER FOURTH FLOOR, 106 S. MAIN STREET, AKRON, OH, 44308, US

(21) Appl. No.: 10/657,635

(22) Filed: Sep. 8, 2003

(51) Int. Cl. A01G 13/02

(52) U.S. Cl. 47/9

(57) ABSTRACT

A single layer ground cover (10) preventing weed growth comprising a fabric (12) providing at least one degradable portion (16) running lengthwise of the fabric and having opposed edges (18,19); and a non-degradable portion (20) adjacent the opposed edges of the degradable portion, wherein the degradable portion comprises from about 5% to about 75% of the area of said ground cover, and wherein the degradable portion substantially degrades before said non-degradable portion after exposure to ambient conditions. A method for facilitating tree growth and preventing weed growth comprises providing a ground cover comprising at least one degradable portion and at least one non-degradable portion; locating the ground cover on a section of ground to be planted; cutting a hole in the degradable portion of the ground cover; planting a plant within the hole; and covering the ground cover with soil sufficiently to at least bury it.

### CROSS-REFERENCE TO RELATED APPLICATIONS

None

### BACKGROUND OF THE INVENTION

This invention relates to ground cover to promote tree and shrub growth by preventing competition from weeds. More specifically, the present invention relates to a weed barrier and artificial mulch, a portion of which is degradable.

Known artificial mulch includes woven and non-woven ground cover fabrics, made of a variety of materials including plastics. Many consist of nothing more than simple sheets of polypropylene. A sheet of artificial mulch is emplaced under flower beds or in landscaped areas in order to prevent the appearance of weeds by providing a physical barrier to the growth of plant life from under the covered area. It is also more commonly used to prevent weed competition when planting young trees or seedlings. Mulch, whether artificial or natural, is employed (1) to prevent the appearance of weeds; (2) to assist in retention of groundwater (preventing evaporation) and (3) to regulate the temperature of the root system of a tree, shrub or other decorative plant, protecting against both extremes of the temperature spectrum.

However, owing to the durability of many thermoplastic polymers, a common drawback of known thermoplastic ground covers is that they can impede the growth of a tree by constraining the lateral growth of the trunk. In the extreme, such physical restriction can harm the roots or trunk of the tree, causing it injury or even death. In conjunction therewith, the lateral growth of a tree trunk tends to stretch the thermoplastic ground cover, causing the ground cover to flex, possibly pulling it out of the ground, and cupping in a phenomenon known in the art as “girdling.” It is then necessary to return to the site and cut away the portion of the cover that is interfering with the growth.

Although many ground covers are durable, most eventually biodegrade. After several years, perhaps five or more, a plastic or other ground cover used as artificial mulch can begin to break down due to wear from atmospheric, oxygenic, halogenic or ozonic action. However, a typical tree will grow more quickly than prior art ground covers biodegrade, resulting in the problems recounted hereinabove. However, to date, no one has made a ground cover that remains largely intact for a time period effective to protect a young tree or sapling from weed competition and conserve groundwater, yet allow the tree to grow in an unrestricted manner.

The patent literature does include several attempts at producing artificial mulch and related ground covers. For example, U.S. Pat. No. 3,886,683 discloses a degradable plastic used to make agricultural mulch film. This degradable plastic is composed of polymers of butene-1 containing a small amount of stabilizer. The degradation rate of the degradable plastic is controlled by the stabilizer. The stabilizer allows degradation of the agricultural mulch film after predetermined exposure to sunlight.

U.S. Pat. No. 3,888,041 discloses knitted fabric mulch used for erosion control, landscaping, irrigation, and growing systems. The knitted fabric mulch is composed of knitting yarns of various materials. The knitted fabric mulch can be configured to incorporate a variety of inserts, including strips of paper, metal, or plastic, and irrigation tubes and/or seed tapes.

U.S. Pat. No. 4,818,585 provides a protective fabric for agricultural purposes which comprises two non-woven fabric layers; a first layer that is non-degradable and a second layer that is photo-degradable. The fabrics can be made from polypropylene fibers, a portion of which are treated to resist degradation and a portion of which are untreated, to allow degradation owing to atmospheric, oxygenic, or other chemical action.

U.S. Pat. No. 5,934,011 discloses a seedling culture mat composed of: an absorbent fibrouus substrate, such as a cellulosic material or a polyolefin; a water soluble film, or paper; and an absorbent polymer. The fibrous substrate may be biodegradable. The polymer is a substantially nonionic water-absorbing polymer, containing up to 20 mole percent ionic polymer, in the form of a film, tape, fiber, or powder, which is anchored to the mat. Seeds of the desired plant are also applied to the mat.

U.S. Pat. No. 5,490,351 discloses a plant sod mat. The plant sod mat is composed of a polyolefin sod reinforcement formed of a pattern bonded polyolefin nonwoven fabric and a layer of planting medium. The plant sod mat can be placed upon black polyethylene sheets to prevent weed propagation.

While attempts have been made heretofore to restrict weed growth by various means, the art has not provided an artificial product by which weed growth can be prevented, and groundwater can be retained, without restricting the growth of a tree.

### BRIEF SUMMARY OF THE INVENTION

In general, the goals of weed prevention and tree growth with respect to the properties of a ground cover fabric result in compromise between the need for a physical barrier sufficiently integral to prevent weed growth at the initial growth stages of a tree, yet degrade quickly enough so as not to hinder the growth of the tree.

It is therefore, an aspect of the present invention to provide a ground cover fabric which facilitates the growth of trees.

It is another aspect of the present invention to provide a woven ground cover fabric having a degradable portion.

It is yet another aspect of the present invention to provide a ground cover which allows free growth of a tree trunk, yet prevents weed competition when the tree is first planted.

It is still another aspect to provide a method of protecting young trees and saplings from weed competition and conservation of groundwater near a tree.

At least one or more of the foregoing aspects, together with the advantages thereof over the known art relating to ground cover and methods for preventing weed growth which shall become apparent from the specification which follows, are accomplished by the invention as hereinafter described and claimed.

In general the present invention provides a single layer ground cover for preventing weed growth comprising a fabric providing at least one degradable portion running lengthwise of the fabric and having opposed edges and a non-degradable portion adjacent the opposed edges of the degradable portion, wherein the degradable portion comprises from about 5% to about 75% of the area of the ground cover, and wherein the degradable portion substantially degrades before the non-degradable portion after exposure to ambient conditions.

The present invention also includes a method for facilitating tree growth and preventing weed growth which comprises providing a ground cover comprising at least one degradable portion and at least one non-degradable portion; locating the ground cover on a section of ground to be planted; cutting a hole in the degradable portion of the ground cover; planting a plant within the hole; and covering the ground cover with soil sufficiently to at least bury it.

### BRIEF DESCRIPTION OF THE DRAWINGS

FIG. 1 is an enlarged perspective view of a portion of the ground cover product of the present invention;

FIG. 2 is a top plan view of a portion of the ground cover product of the present invention;

FIG. 3 is a perspective view depicting a length of the ground cover product of the present invention in use; and

FIG. 4 is a perspective view of another embodiment of a ground cover product of the present invention.

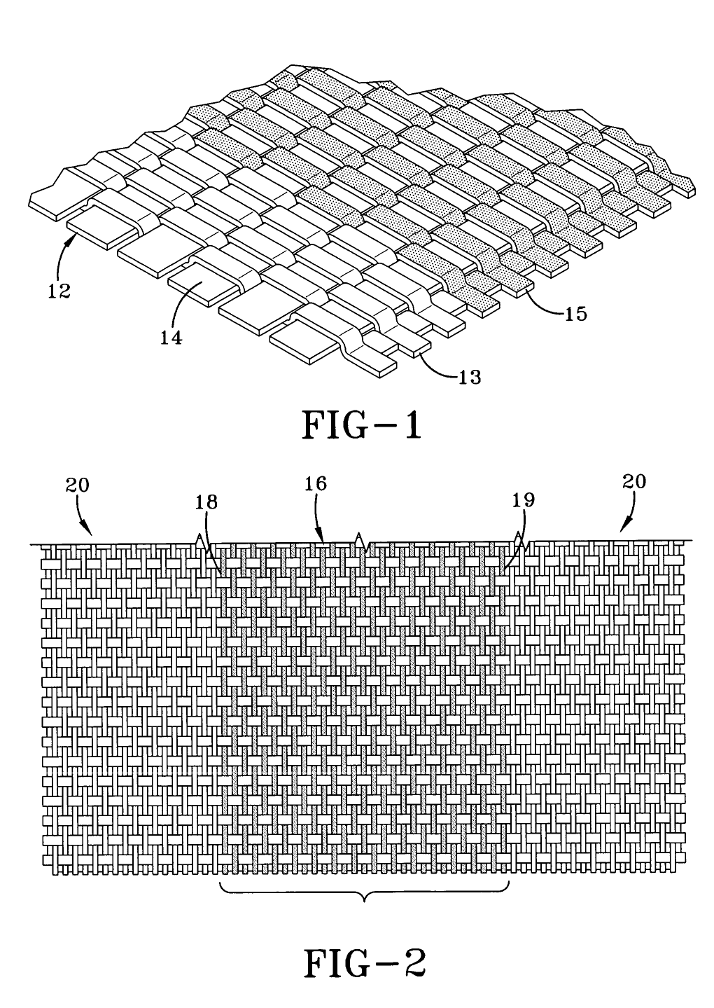

### DETAILED DESCRIPTION OF THE INVENTION

The present invention provides an artificial ground cover for preventing weed growth. Since the primary purpose of ground cover is to prevent the appearance of unwanted plants (i.e., weeds) a portion of the ground cover is “non-degradable,” It is a desired property of the inventive ground cover to present a physical barrier preventing the appearance of weeds in a landscaped area. Because weeds are generally never wanted, a ground cover desirably performs the weed prevention function for an extended period. It is understood that the term “non-degradable” when applied to a polymer, is meant in a relative sense. A polymer is “non-degradable” as used herein when it maintains its substantial physical and chemical integrity for a period exceeding 60 months after initial exposure to sustained atmospheric conditions.

The degradable portion of ground cover of the present invention “degrades” when it loses its substantial physical and chemical integrity. Of interest herein is the point at which the ground cover will not impede the lateral growth of e.g., a tree planted through the ground cover. In particular, the term degradable includes photo-degradable. The term “photodegradable” when applied to a polymer means that, by the action of ambient atmospheric ozone, ionic halogen or oxygen radicals, or incident electromagnetic energy comprising the infrared, visible and ultraviolet ranges, the polymer in question loses its physical or chemical integrity (or both) before the non-degradable portion after initial exposure to the factors mentioned. Generally, this period is about 12 to about 24 months.

The degradable portion of the inventive ground cover exists in order to assist the growth of an immature sapling, allowing it to become established by providing the following benefits: (1) to prevent the appearance of weeds; (2) to assist in retention of groundwater (preventing evaporation) and (3) to regulate the temperature of the root system of a tree, shrub or other decorative plant, protecting against both extremes of the temperature spectrum.

However, once ground cover has initially protected the sapling, allowing it to take root and become established, the same ground cover can later interfere with the continued growth of the sapling. Because a young tree may eventually grow to a point where the diameter of its trunk may exceed the opening originally cut through the ground cover, a prior art ground cover would have to be cut, while the ground cover of the present invention begins to degrade, reducing its hold on the growing tree trunk, and avoiding it being pulled up from the ground. To this end, the inventive ground cover may typically have its degradable portion comprise from about 5% to about 75% of the area of the ground cover, with from about 15% to about 50% being preferred. These percentages can be smaller or greater than those set forth here where special circumstances may exist and dictate that smaller or larger degradable portions be utilized for any of a number of reasons including, for example, spacing between plants. Typically the degradable portion of the ground cover will occupy a central portion of the width of the ground cover.

The ground cover material, indicated generally by the numeral 10 is a single layer fabric, preferably manufactured from synthetic polymers or natural fibers, and includes all known forms such as woven, non-woven, and sheets or films. With reference to the drawing figures, an exemplary woven fabric is depicted, indicated generally by the numeral 12. The fabric is woven with slit film tapes 13 and 14, the former being depicted in the machine direction and the latter being depicted in the cross-machine, or fill, direction. Such weaves are generally of an open or closed nature, an open weave being depicted, and the use of flat or slit film tapes as the yarn is well known. Accordingly, the configuration of the yarn does not constitute a limitation of the present invention, as round monofilaments and fibrillated yarns could alternatively be employed.

Unlike existing fabrics, however, the ground cover fabric of the present invention employs degradable yarns, indicated by the numeral 15, in the drawings and seen to run in the machine direction. Preferably, the degradable yarns 15 are located in a strip running along the length and through the center of the ground cover fabric 10, providing a degradable zone or portion, generally 16, having opposed sides or edges 18 and 19 and non-degradable zones or portions, generally 20, which are adjacent said sides 18 and 19. In this embodiment, the degradable portion 16 may preferably range in widths of from about 12 to about 24 inches, depending upon the width of the cover, with about 18 inches being preferred. Each non-degradable portion 20 can range in widths of from about 9 inches to about 5 feet, again depending upon the width of the cover, with about 27 inches being preferred.

While one degradable portion 16 is sufficient, it is another embodiment of and within the scope of the present invention as shown in FIG. 4 to provide multiple degradable portions 16, at repeating intervals across the width of the ground cover 10, with non-degradable zones or portions 20 separating the degradable zones or portions 16. Generally, the alternating non-degradable zones 20 will be wider than the degradable zones.

The ground cover of the present invention is typically manufactured as a rolled fabric, which may be on the order of about 2 to 20 feet wide, and hundreds or thousands of feet long, owing to modern continuous manufacturing processes. Length of the fabric and its method of manufacture are not limitations of the present invention, and the width of the fabric is generally limited by the size of the operating loom.

Degradable portion(s) 16 of the fabric may be made from synthetic or natural materials selected from the group consisting of polyolefins such as polypropylene, polyamides such as nylon, and natural fibers such as cotton or jute. A preferred material is polypropylene. The non-degradable portions 20 may be made from any of a number of known non-degradable synthetic materials selected from the group consisting of a polyolefin and polyesters. To be non-degradable as defined herein, the polyolefins include a UV stabilizer, such as carbon black or hindered amine, or a combination thereof. These UV stabilizers may have provide other functions to the synthetic materials beyond UV stability.

For example, one embodiment of the present invention provides a woven ground cover sheet having a length substantially longer than its width, comprising warp fibers and weft fibers, wherein preferably the central portion of the warp fibers comprise a degradable polyolefin, and the remaining warp fibers comprise a polyolefin and a UV stabilizer. The weft fibers comprise a polyolefin and a UV stabilizer, for both the degradable and non-degradable portions. Generally, the degradable portion substantially degrades within about 12 to about 24 months after exposure to ambient conditions. Namely, the warp fibers degrade, allowing room for tree trunk growth, while the weft fibers remain intact, thereby maintaining integrity of the ground cover 10. One example of a suitable non-degradable, synthetic fiber is described in U.S. Pat. No. 6,559,702, the disclosure of which is incorporated herein by reference.

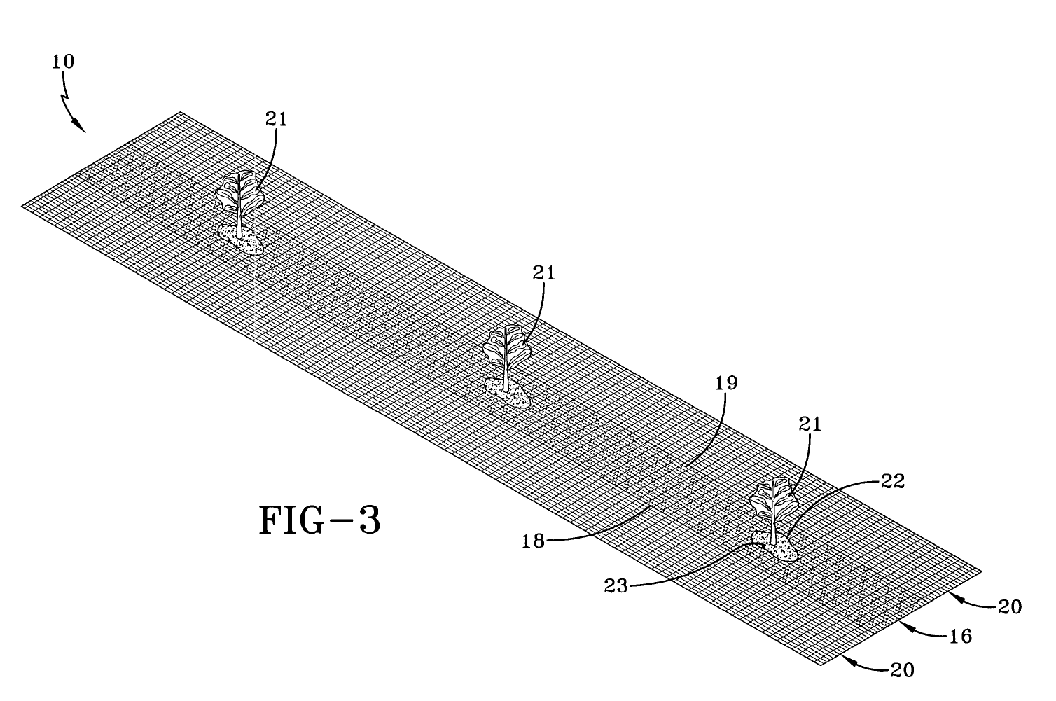

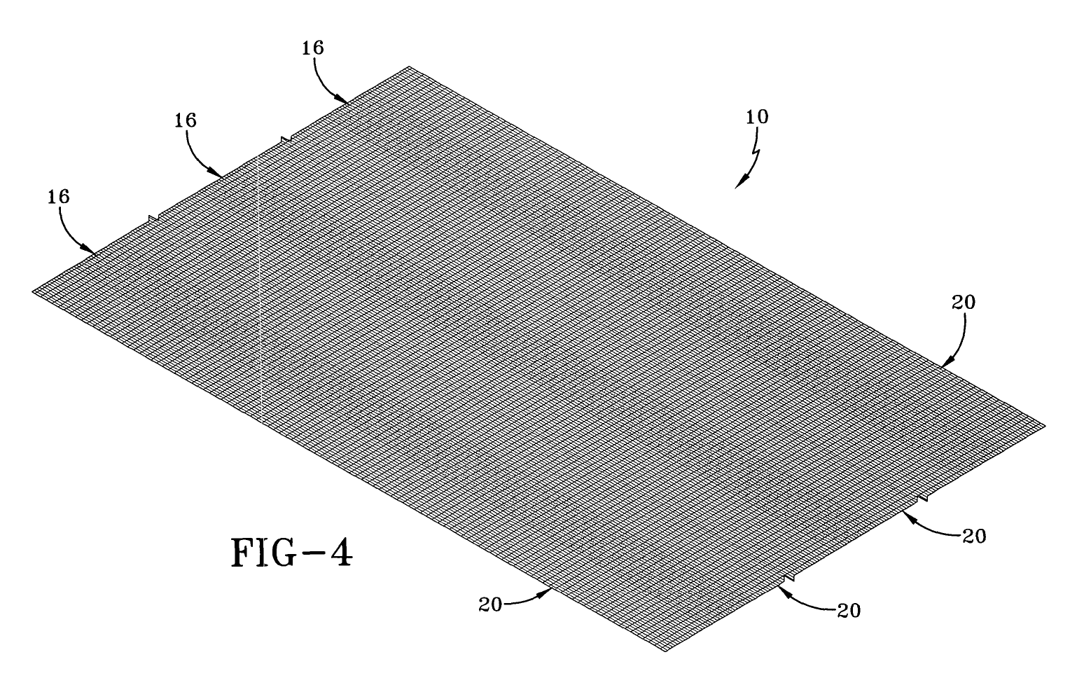

In landscaping projects, trees are often planted in a straight line, set at regular intervals, for example, to form a border along the edge of a parcel of land. The method of the present invention includes placing the ground cover 10 within the ground at a depth of several inches. Next, spaces or holes are cut through the degradable zone, and tree saplings are planted therein. With reference to FIG. 3, a length of ground cover 10 is depicted, with the overlying soil not shown for purposes of clarity. A plurality of trees 21 are planted in the zone 16, which is partially cut away from the trunk area, as at 22, exposing a portion of the underlying soil 23, which may optionally be covered with mulch or the like, not shown. After planting, the remaining portions of cover 10 can be covered with soil to a depth of several inches. When the tree is young, the ground cover 10 is intact, and prevents weed growth in the landscaped area. As the tree develops, its diameter increases, and the ground cover begins to degrade in the zone 16, thereby allowing the tree to grow unimpeded.

Thus, it should be evident that the ground cover and method of the present invention are highly effective in preventing weed growth and facilitating tree growth. The invention is particularly suited for landscaping applications, but is necessarily limited thereto. The ground cover and method of the present invention can be used separately with other equipment, methods and the like, as well as for the planting of other flora, including shrubs, bushes and the like.

Based upon the foregoing disclosure, it should now be apparent that the use of the ground cover described herein will carry out the objects set forth hereinabove. It is, therefore, to be understood that any variations evident fall within the scope of the claimed invention and thus, the selection of specific component elements can be determined without departing from the spirit of the invention herein disclosed and described. In particular, ground covers according to the present invention are not necessarily limited to those having degradable areas distributed at regular intervals. Moreover, as noted hereinabove, other types of fabrics and film or sheet products can be substituted for the woven product described. Thus, the scope of the invention shall include all modifications and variations that may fall within the scope of the attached claims.

1. A single layer ground cover for preventing weed growth comprising:
a fabric providing at least one degradable portion running lengthwise of the fabric and having opposed edges; and
a non-degradable portion adjacent said opposed edges of said degradable portion, wherein said degradable portion comprises from about 5% to about 75% of the area of said ground cover, and wherein said degradable portion substantially degrades before said non-degradable portion after exposure to ambient conditions.

2. The ground cover of claim 1, wherein said ground cover is a woven fabric and said degradable portion comprises degradable warp yarns and non-degradable weft yarns and said non-degradable portion comprises non-degradable warp and weft yarns.

3. The ground cover of claim 2, wherein said at least one degradable portion consists essentially of a polyolefin and said at least one non-degradable portion comprises a polyolefin and a UV stabilizer.

4. The ground cover of claim 3, wherein said polyolefin is polypropylene.

5. The ground cover of claim 3, wherein said UV stabilizer is selected from the group consisting of carbon blacks, hindered amines, and mixtures thereof.

6. The ground cover of claim 6, wherein said degradable portions comprise from about 15% to about 50% of the area of said ground cover.

7. The ground cover of claim 1, wherein said degradable portion substantially degrades within about 12 to about 24 months after exposure to ambient conditions.

8. The ground cover of claim 1, having a plurality of said degradable portions at repeating intervals across the width of said fabric, separated by non-degradable portions.

9. A method for facilitating tree growth and preventing weed growth comprising:
providing a ground cover comprising at least one degradable portion and at least one non-degradable portion;
locating the ground cover on a section of ground to be planted;
cutting a hole in said degradable portion of the ground cover;
planting a plant within said hole; and
covering said ground cover with soil sufficiently to at least bury it.

10. A method for facilitating tree growth, as set forth in claim 9, wherein said step of providing a ground cover comprises selecting a single layer ground cover for preventing weed growth comprising
a fabric providing at least one degradable portion running lengthwise of the fabric and having opposed edges; and
a non-degradable portion adjacent said opposed edges of said degradable portion, wherein said degradable portion comprises from about 5% to about 75% of the area of said ground cover, and wherein said degradable portion substantially degrades before said non-degradable portion after exposure to ambient conditions.
